(19) United States
(12) Patent Application Publication
(10) Pub. No.: US 2019/0039137 A1
(43) Pub. Date: Feb. 7, 2019

(54) PROCESS CONTROLLED DISSOLVABLE SUPPORTS IN 3D PRINTING OF METAL OR CERAMIC COMPONENTS

(71) Applicants: ARIZONA BOARD OF REGENT ON BEHALF OF ARIZONA STATE UNIVERSITY, Scottsdale, AZ (US); THE PENN STATE RESEARCH FOUNDATION, University Park, PA (US)

(72) Inventors: Owen HILDRETH, Tempe, AZ (US); Keng HSU, Tempe, AZ (US); Abdalla NASSAR, State College, PA (US); Timothy W. SIMPSON, State College, PA (US)

(21) Appl. No.: 16/076,524

(22) PCT Filed: Feb. 16, 2017
(86) PCT No.: PCT/US2017/018096

§ 371 Date: Aug. 8, 2018

Related U.S. Application Data
(60) Provisional application No. 62/295,918, filed on Feb. 16, 2016.
(60) Provisional application No. 62/400,464, filed on Sep. 27, 2016.

(51) Int. Cl. B22F 3/105; B33Y 10/00

(52) U.S. Cl. CPC B22F 3/1055; B22F 2003/1042; B22F 2003/1058; B33Y 10/00

(57) ABSTRACT

Systems and methods are described for fabricating a metal or ceramic component using 3D printing. A 3D printed piece is created that includes a body of the component and a support structure. While the 3D printed piece is created using a single printing material, one or more processing parameters are adjusted while printing a first sacrificial interface region coupling the body of the component to the support structure. The body of the component is separated from the support structure by applying a chemical or electrochemical dissolution process to the 3D printed piece. The adjustment to the one or more processing parameters during printing of the first sacrificial interface region creates a localized area that is less resistant to the chemical or electrochemical dissolution process than the body of the component.

### RELATED APPLICATIONS

This application claims the benefit of U.S. Provisional Patent Application No. 62/295,918, filed Feb. 16, 2016, entitled “PROCESS CONTROLLED DISSOLVABLE SUPPORTS IN 3D METALS PRINTING,” and U.S. Provisional Patent Application No. 62/400,464, filed Sep. 27, 2016, entitled “DIRECT SUPPORT DISSOLUTION FOR 3D PRINTED METALS AND OXIDES,” the entire contents of both of which are incorporated herein by reference.

### BACKGROUND

The present invention relates to techniques for fabricating components using 3D printing.

### SUMMARY

When the supports used during fabrication of a component must be machined off, this adds considerable expense (sometimes higher than the cost of the original part) such that it often pushes the cost of 3D printing higher than that of a traditional “subtractive” manufacturing process. Additionally, these supports inherently limit the size and complexity of the parts that can be fabricated using “monolithic” or single material printing. For example, in order to use 3D printing techniques to fabricate a frame for a car, the resulting frame would be designed in a way that is large, heavy, and geometrically awkward—making it extremely difficult to machine into final size and tolerance. The cost of a milling machine that size would be extremely high and manipulating the part into the machine with the necessary precision would be difficult and would likely require specialized tooling just for that part.

In various embodiments, the systems and methods described in this disclosure provide for easy removal of supports or sections of a 3D printed metal or ceramic piece by incorporating dissolvable (either chemically or electrochemically) removable elements into the structure. This new process dramatically simplifies the support removal process for metals while also opening up new design freedoms by removing the restriction that support structures must be machine accessible—now they must be merely fluid accessible.

Processing conditions experienced by materials during 3D printing impact the resulting microstructure including, for example, morphology, grain structure, alloying, intermetallics, precipitates, and porosity. All of these microstructural features impact the mechanical properties and the chemical stability of a printed material. These differences in properties can be exploited to create localized areas of structural and chemical weaknesses so that support structures can be easily removed without requiring machining operations.

For example, increasing the porosity of a support at the support/component interface will create a region with increased surface area that will dissolve at a faster rate than the bulk component material. Since the support/component interface can be less than 1 mm in size, increasing the local surface area by a factor of 10 will enable the supports to be completely removed while only 100 μm of the bulk component is dissolved.

In another approach, the temperature profile experienced at the support/component interface can be adjusted to form precipitates or microstructures that locally decrease the chemical resistance of the interface. For example, FIG. 1 shows how heating stainless steel to around 427° C. to 850° C. can create precipitates of chromium carbide at grain boundaries. These precipitates locally deplete the protective chromium from the grain, leading to decreased chemical resistance. Additionally, precipitates and intermetallics can create differences in electrochemical processes that promote localized corrosion. By locally controlling the formation of the microstructure at the support/component interface, regions of increased etch rate are created so that the support is rapidly removed from the component without machining.

These regions can be created by controlling and adjusting temperature, time, power density, thermal cycling, deposition material, chemical environment, and elemental composition. For example, time at the critical mid-range temperatures can be controlled—when 3D printing with steel, a few seconds at 1200° F. (649° C.) can do more damage than several minutes at 850° F. (454° C.) or 1450° F. (788° C.). Welding naturally produces a temperature gradient in the steel. It ranges from melting temperature at the weld to room temperature some distance from the weld. A narrow zone on each side of the weld remains in the sensitizing temperature range for sufficient time for precipitation to occur. If used in severely corrosive conditions, lines of damaging corrosion appear alongside each weld.

In one embodiment, the invention provides a method of fabricating a metal part wherein a dissolvable or sacrificial section is incorporated into a 3D printed metallic part during printing by adjusting processing parameters. In some embodiments, the sacrificial section includes an increased porosity and surface area. In other embodiments, the sacrificial section includes precipitates that deplete protective elements. In still other embodiments, the sacrificial section includes increased intermetallics. In yet other embodiments, the sacrificial section creates localized differences in chemical potential.

In such embodiments, the dissolvable or sacrificial material is less chemically stable in an etchant solution than the part material. In other embodiments, the dissolvable or sacrificial material is less electrochemically stable in an electrochemical bath than the part material.

In another embodiment, the invention provides a method of fabricating a metal or ceramic component using 3D printing. A 3D printed piece is created that includes a body of the component and a support structure. While the 3D printed piece is created using a single printing material, one or more processing parameters are adjusted while printing a first sacrificial interface region coupling the body of the component to the support structure. The body of the component is separated from the support structure by applying a chemical or electrochemical dissolution process to the 3D printed piece. The adjustment to the one or more processing parameters during printing of the first sacrificial interface region creates a localized area that is less resistant to the chemical or electrochemical dissolution process than the body of the component.

In some embodiments, additives, chelating agents, complexing agents, accelerating agents, and/or inhibiting agents are added to the chemical bath to promote dissolution of the sacrificial interface region of the 3D printed material or to increase the solubility of the sacrificial material at the sacrificial interface region. In some embodiments, etchant solutions are used that will selectively etch the material at the sacrificial interface region with acceptably low etch rates for the part of the material forming the component.

In some embodiments, the sequence of dissolvable metallic material removal is adjusted by altering different processing parameters while printing the 3D printed structure at different sacrificial interface regions resulting in varying degrees of stability at the different sacrificial interface regions during chemical or electrochemical etching. Sections can thus be selectively etched or sequenced by varying chemical or electrochemical stability (redox potential) or by varying support length or geometry (e.g., by adjusting the cross-section of the dissolvable support).

In some embodiments, the processing parameters are adjusted gradiently at the sacrificial interface regions to impart beneficial material properties (strength, coefficient of thermal expansion, modulus, chemical purity, chemical resistance, and more). In other embodiments, the processing parameters are adjusted to leave behind a porous structure after removal or to leave behind a small undissolved section of the material at the sacrificial interface region for chemical, mechanical, or alloying purposes.

In some embodiments, the distance between the part and the dissolvable section are adjusted to minimize diffusion of the dissolvable portion of the material (created by adjusting the processing parameters during printing) into the portion of the material forming the body of the component and/or to minimize the amount of support material that must be removed in post-processing

In some embodiments, a mix of sequence of chemical and/or electrochemical dissolution pathways are designed and used to control the processing of the part. In some such embodiments, the electrochemical process or the chemical etching/dissolution process is self-limiting or stopping.

In some embodiments, additives are added to the etchant/electrolyte to passivate or protect the part material or other sections or to make the dissolvable sections more susceptible to chemical or electrochemical dissolution.

In some embodiments, the etchant is delivered in liquid form. In other embodiments, the etchant is delivered in vapor form such as, for example, an HF vapor etchant with SiO₂ support material. In still other embodiments, the etchant is delivered in solid form such as, for example, Ga etchant with aluminum support material.

Other aspects of the invention will become apparent by consideration of the detailed description and accompanying drawings.

### BRIEF DESCRIPTION OF THE DRAWINGS

FIG. 1 is a schematic view of precipitates formed in 3D printed steel material.

FIG. 2 is a schematic diagram of a method of fabricating a part using machining techniques.

FIG. 3 is a schematic diagram of a method of fabricating a component using dissolvable sacrificial interface regions formed by adjusting processing parameters during printing and offset from the component.

FIG. 4 is a schematic diagram of a method of fabricating a component using dissolvable sacrificial interface regions formed by adjusting processing parameters during printing at the interface between the component and a support structure.

FIG. 5 is a schematic diagram of a method of fabricating a component by printing multiple different sacrificial interface regions each formed by different adjustments to the processing parameters during printing of the sacrificial interface region to control the sequencing by which the component is separated from the support structure.

FIG. 6 is a schematic diagram of a method for separating a fabricated component from a support structure using a uniformly dissolvable sacrificial interface region.

FIG. 7 is a schematic diagram of a method for separating a fabricated component from a support structure suing a dispersive dissolvable sacrificial interface region.

FIG. 8 is a schematic diagram of a method for separating a fabricated component from a support structure using a gradient dissolvable sacrificial interface region.

FIG. 9 is a schematic diagram of a method for separating a fabricated component from a support structure using a partially-dissolvable, partially-remnant sacrificial interface region.

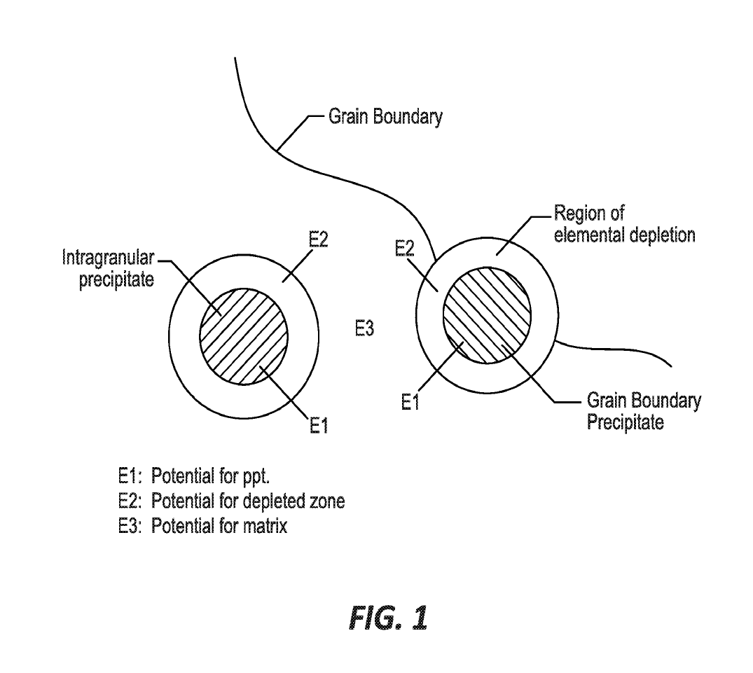

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

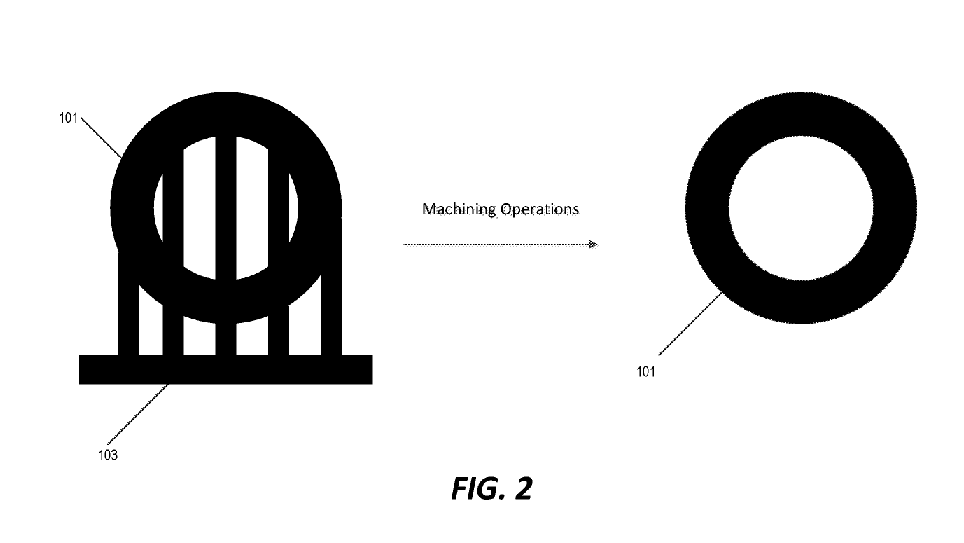

FIG. 2 illustrates an example of a method of manufacturing a metal or ceramic component 101 using 3D printing techniques. The component 101 and a support structure 103 are “printed” from the same metal or ceramic material (e.g., stainless steel, titanium, silicon carbide, etc.). After the component 101 and the support structure 103 are created using monolithic support strategies, complicated and intricate machining operations are needed to remove the support structures from the component. These machining operations add cost and impose design restrictions on the part. Machine shops typically charge between $30-$100 per hour for machine time and the monolithic structure must be designed such that the support structures 103 are accessible to the tool. This accessibility requirement limits the types of shapes that can be fabricated and/or may require additional features on the part/support so that the part can be held while supports are being machined. Overall, this process is costly and adds unwanted complexity to the design, fabrication, and post-processing steps.

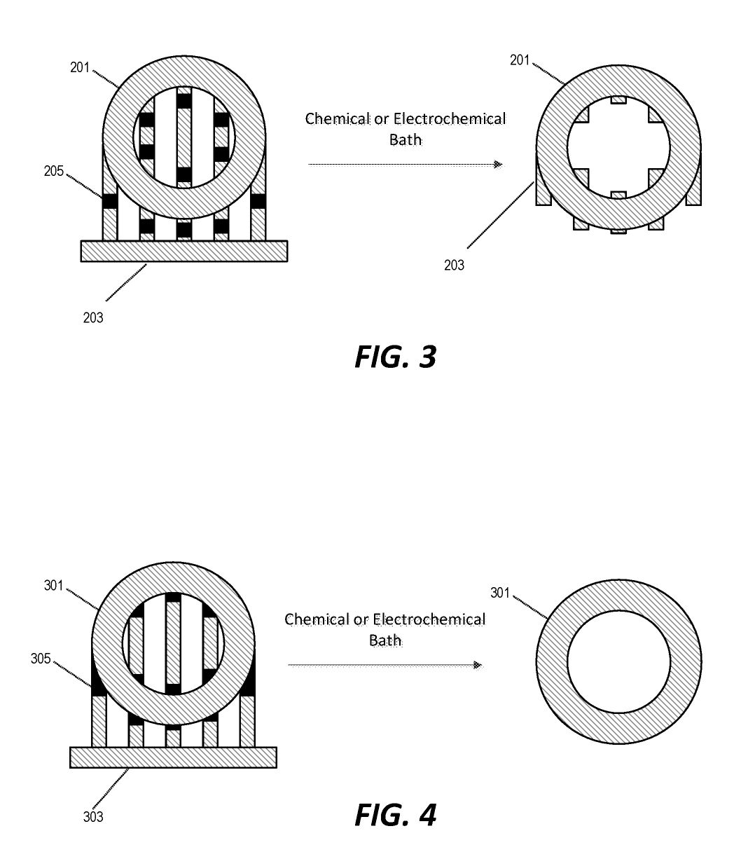

The methods illustrated in FIGS. 3-5 control the printing process to create localized regions of increased corrosion susceptibility or mechanical weakness. When additive manufacturing was initially being developed, the material properties were extremely poor—parts were porous, had unwanted precipitates, and were mechanically weak. Over the last three decades, considerable progress has been made developing printing processes that produced high-quality, dense materials with excellent mechanical properties. In some implementations, printing parameters are adjusted while printing a sacrificial interface region between a body of the component and the support structure from those “good” recipes to “bad” recipes that produce a localized region of increased porosity, increased precipitates, increased intermetallics, and reduced corrosion resistance.

Schematically illustrated in FIG. 3, the printed material at the sacrificial interface regions 205 will typically have lower chemical or electrochemical stability compared to the same printed material forming the body of the component 201. As a result, the sacrificial interface regions 205 will dissolve in chemical or electrochemical bath at a higher rate compared to the body of the component 201. For example, a dissolvable material at the sacrificial interface region 205 can be created while printing a stainless steel component 201 by controlling the laser power and time duration such that the material printed at the sacrificial interface region is held at 650° C. for a defined period of time to form chromium-depleting chromium carbide precipitates. Alternatively, the laser power could be reduced while printing the sacrificial interface regions to a level just above the sintering temperature so that the metal or oxide particles are sintered, but not dense—forming a porous structure with increased surface area. Locally increasing the surface area will allow the material at the sacrificial interface region 205 to dissolve at a faster rate compared to the dense component material.

This technique covers a broad range of metal and ceramic materials used to “print” or create the 3D printed piece. In various implementations, printing, manufacturing, and/or fabrication processes are designed or adjusted to create a section of the 3D printed material that is less chemically or electrochemically stable than the portion of the same material used to form the body of the component being fabricated. Additionally, the electrolyte and complexing agents may be adjusted to control the solubility of the dissolved sacrificial material. Additives may be added that improve passivation of the part material or selectively remove passivation on the sacrificial material.

In the example of FIG. 3, the dissolvable sacrificial interface regions 205 (formed by altering one or more processing parameters while printing the sacrificial interface regions 205) are offset from the body of the component 201 to preserve the material purity of the component. Once dissolved, the body of the component 201 may need additional machining or polishing operations to achieve tolerances or surface finishes, but generally not for separating the body of the component 201 from the support structure 203. FIG. 4 illustrates an alternative example where the sacrificial interface regions 305 are formed by adjusting the processing parameters while printing at the interface between the body of the component 301 and the support structure 303. As a result, the sacrificial interface region 305 is formed up to or almost up to the body of the component 301 thereby eliminating, reducing, or minimizing the need for post-processing after the body of the component 301 is separated from the support structure 303 during the chemical or electrochemical dissolution process.

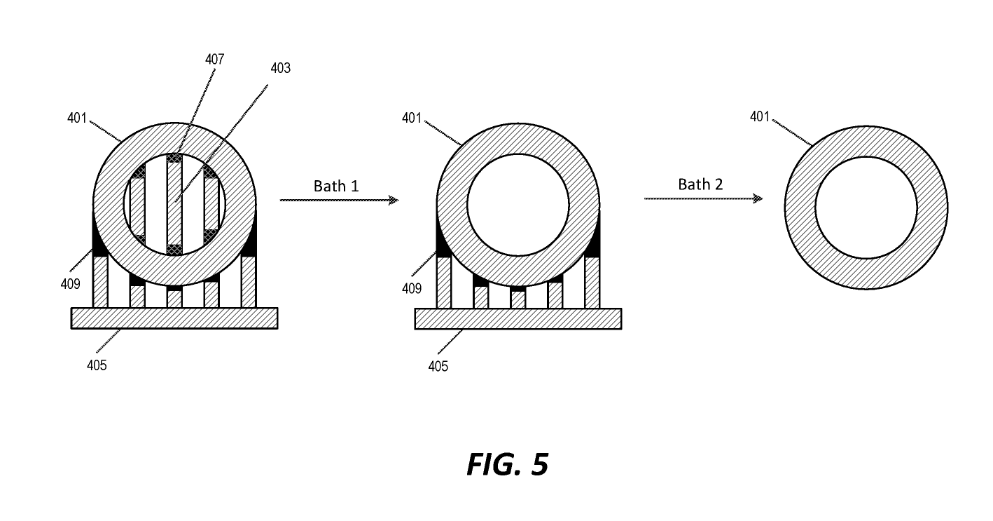

FIG. 5 illustrates a two-step process in which multiple different sacrificial interface regions are created to make dissolution (and separation of the body of the component from the support structure) a controllable, sequential process where, first, the less stable sacrificial interface regions are removed and then other sacrificial interface regions are dissolved in later steps In particular, the 3D printed piece is created by printing with a metal or ceramic material and includes a body of the component 401, a first set of support structures 403 inside the body of the component 401, and a second set of support structures 405 below the body of the component 401. In this example, the body of the component 401 and both sets of support structures 403, 405 are printed from the same material (e.g., stainless steel, titanium, or silicon carbide).

A first sacrificial interface region 407 is formed between the body of the component 401 and the first set of support structures 403 by printing with the same material used to print the body of the component 401 and the support structures 403, 405, but adjusting one or more of the processing parameters so that the one or more processing parameters used while printing the first sacrificial interface regions 407 are different than the one or more processing parameters used while printing the body of the component 401. As described above, these adjustments to the one or more processing parameters may include, for example, an adjustment to one or more of the following printing parameters: material temperature, time, power density, thermal cycling, and/or chemical environment.

Similarly, a second sacrificial interface region 409 is formed between the body of the component 401 and the second set of support structures 405. The processing parameters used while printing the second sacrificial interface regions 409 are also adjusted so that the stability of the second sacrificial interface regions 409 is different than the stability of both the first sacrificial interface regions 407 and the body of the component 401 when the chemical or electrochemical dissolution process is applied. In various embodiments, this can be achieved, for example, by making further adjustments to the same processing parameters that were adjusted while printing the first sacrificial interface regions 407 and/or making adjustments to other different processing parameters.

As a result of the different adjustments to the processing parameters while printing the first sacrificial interface regions 407 and the second sacrificial interface regions 409, the first sacrificial interface regions 407 dissolve when the 3D printed piece is placed in a first chemical or electrochemical bath, thereby separating the body of the component piece 401 from the first set of support structures 403. However, because of the adjustments made to the one or more processing parameters while printing the first sacrificial interface regions 407, the stability of the material at the first sacrificial interface regions 407 is lesser than the stability of the rest of the 3D printed piece during the first chemical or electrochemical bath. Accordingly, the body of the component 401 remains intact and the second sacrificial interface regions 409 are not dissolved during the first bath and the body of the component 401 remains coupled to the second set of support structures 405. However, when the 3D printed piece is placed in a second chemical or electrochemical bath (e.g., a machine metrology bath), the second sacrificial interface regions 409 dissolve and the body of the component 401 is separated from the second set of support structures 405.

Note, although the term “support” is used in the discussion of the preceding examples, the dissolvable sections could be incorporated into multiple sections of the part with various other applications. For example, the processing parameters during the 3D printing process could be controllably altered to create a sacrificial anode incorporated directly into the 3D printed piece similar to how zinc rods are attached to water heaters as a sacrificial material that prevents galvanic corrosion of the more expensive water heater parts.

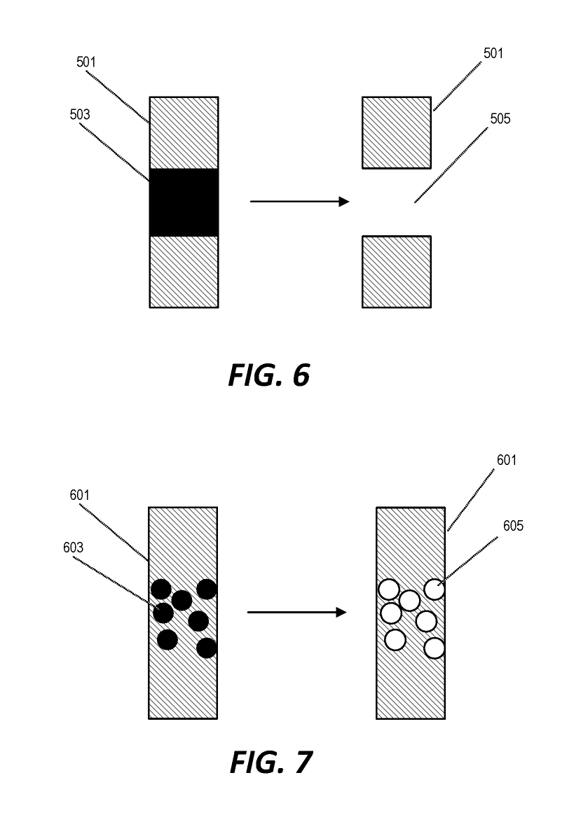

FIGS. 6-9 illustrate some examples of techniques for structuring the sacrificial interface region by controllably adjusting the processing parameters during of the sacrificial interface region to more directly control how the body of the component is shaped and/or separated from the support structure. In the example of FIG. 6, the processing parameters are controllably adjusted during 3D printing so that dissolvable material 503 is uniformly deposited between the material forming the body of the component 501 and the support structures such that, when the dissolvable material 503 is removed, the body of the component 501 is completely separated from the support structure (e.g., space 505).

FIG. 7 illustrates an example in which the processing parameters are controllably adjusted during 3D printing so that dissolvable material 603 is dispersively deposited within the material forming the body of the component 601 such that, when the dissolvable material 603 is dissolved by the chemical or electrochemical dissolution process, dispersed sections of the support structure are dissolved leaving a weakened support 605. The remaining weakened support 605 could also be further dissolvable by additional processing or separated by machining.

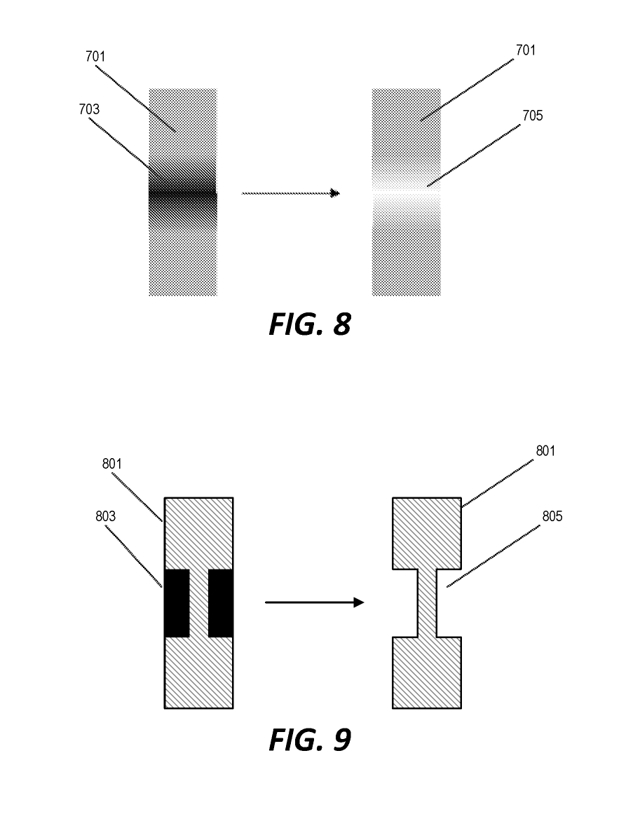

FIG. 8 illustrates an example that controllably adjusts the processing parameters during 3D printing to provide a gradient deposition of the dissolvable material 703 within the material forming the body of the component 701 causing a similarly gradient separation 705 when the chemical or electrochemical dissolution process is applied. In some implementations, this gradient structuring of the sacrificial interface regions keeps the dissolvable material from diffusing into the body of the component 701 and prevents the adjusted processing parameters used during printing of the sacrificial interface region from adversely affecting the structure and stability of the body of the component 701.

Finally, in the example of FIG. 9, the processing parameters are adjusted during printing of the sacrificial interface region so that the dissolvable material 803 forms only a partial cross-section of the 3D printed piece at the sacrificial interface region. Dissolving the dissolvable material 803 during the chemical or electrochemical dissolution process crosses only partly through the material (e.g., space 805). The remaining portion of the material 801 can then be removed mechanically or by further chemical or electrochemical processing. Alternatively, this partial/remnant support technique can be utilized to fabricate small features of the component 801.

In various implementations of the processes described above, a 3D printed piece, including both the body of the component and support structures, is printed using a single metal or ceramic material. However, sacrificial/dissolvable/breakable sections are created by adjusting the processing conditions to form, for example, increased porosity, precipitates, alloys, and intermetallics while printing the sacrificial interface regions between the body of the component and the support structures. Because the material printed under these altered conditions/processing parameters will be less chemically or electrochemically stable compared to the material forming the body of the component, the body of the component is separated from the support structures when the 3D printed piece is placed in a chemical or electrochemical bath designed to selectively remove the sacrificial material. Holding the stainless steel part at 650° C. for a few seconds can form chromium carbide precipitates at the grain boundaries, these precipitates deplete the chromium from the grain interiors and lead to increased corrosion susceptibility.

Both chemical and electrochemical dissolution systems can be designed to provide flexibility in terms of processing and sequencing. For example, a chemical dissolution path could be used first followed by an electrochemical dissolution path (or some combination thereof). Additionally, in some implementations, the supports and/or part materials are not necessarily limited to metals. As discussed above, controlling process variations can be used to create a sacrificial interface region while printed with ceramic or oxide materials. Similarly, in still other implementations, a sacrificial interface region can be created while printing with other materials including, for example, polymers by controllably adjusting printing process variables such as those discussed above and other variables that affect, for example, the stability, porosity, and dissolvability of the particular material that is being used for the printing process.

Thus, the invention provides, among other things, a method of fabricating a metal or ceramic component using 3D printing techniques that incorporate mechanically and/or chemically unstable sections specifically designed to be removed through chemical, electrochemical, or mechanical processes for the purpose of support (or other structure) removal. Various features and advantages of the invention are set forth in the following claims.

What is claimed is:

1. A method of fabricating a metal or ceramic component, the method comprising:
creating a 3D printed piece using 3D printing, the metal or ceramic piece including a body of the component and a support structure,
wherein creating the 3D printed piece includes adjusting one or more processing parameters while printing a first sacrificial interface region coupling the body of the component to the support structure, the first sacrificial interface region being printed from a same metal or ceramic material as the body of the component and the support structure; and
separating the body of the component from the support structure by applying a chemical or electrochemical dissolution process to the 3D printed piece,
wherein adjusting the one or more processing parameters while printing the first sacrificial interface region creates a localized area that is less resistant to the chemical or electrochemical dissolution process than the body of the component.

2. The method of claim 1, wherein adjusting the one or more processing parameters while printing the first sacrificial interface region includes adjusting one or more processing parameters selected from a group consisting of temperature, time, power density, thermal cycling, and chemical environment.

3. The method of claim 1, wherein adjusting the one or more processing parameters while printing the first sacrificial interface region includes generating a localized area with increased porosity at the first sacrificial interface region, and wherein increasing the porosity of the first sacrificial interface region causes the first sacrificial interface region to dissolve more quickly during the chemical or electrochemical dissolution process by creating a greater surface area contacting a chemical bath during the chemical or electrochemical dissolution process.

4. The method of claim 1, wherein adjusting the one or more processing parameters while printing the first sacrificial interface region includes generating precipitates that deplete protective elements at the first sacrificial interface region, and wherein depleting the protective elements causes the first sacrificial interface region to dissolve more quickly during the chemical or electrochemical dissolution process.

5. The method of claim 1, wherein adjusting the one or more processing parameters while printing the first sacrificial interface region includes increasing intermetallics at the first sacrificial interface region, and wherein increasing the intermetallics causes the body of the component to separate from the support structures more quickly during the chemical or electrochemical dissolution process.

6. The method of claim 1, wherein adjusting the one or more processing parameters while printing the first sacrificial interface region includes creating localized differences in chemical potential of the metal or ceramic material used to create the 3D printed piece, and wherein the localized differences in the chemical potential of the metal or ceramic material causes the body of the component to separate from the support structures more quickly during the chemical or electrochemical dissolution process

7. The method of claim 1, wherein creating the 3D printed piece includes printing the body of the component at a first defined temperature, and wherein adjusting the one or more processing parameters while printing the first sacrificial interface region includes adjusting a temperature of the metal or ceramic material to a defined mid-range temperature while printing the first sacrificial interface region.

8. The method of claim 7, further comprising adjusting the temperature of the metal or ceramic material from the defined mid-range temperature to the first defined temperature after printing at least a portion of the first sacrificial interface region and before continuing to print the body of the component.

9. The method of claim 7, wherein printing the first sacrificial interface region at the defined mid-range temperature causes precipitation and corrosion to occur at the first sacrificial interface region, and wherein the occurrence of precipitation and corrosion causes the first sacrificial interface region to dissolve more quickly during the chemical or electrochemical dissolution process.

10. The method of claim 9, wherein the creating the 3D printed piece includes printing the 3D printed piece from stainless steel, and wherein adjusting the temperature of the metal or ceramic material to a defined mid-range temperature while printing the first sacrificial interface region includes adjusting the temperature of the stainless steel to approach 1200° F.

11. The method of claim 1, wherein creating the 3D printed piece further includes adjusting another one or more processing parameters while printing a second sacrificial interface region coupling the body of the component to the support structure,
wherein the printing of the second sacrificial interface region is controlled to create a second sacrificial interface region that will cause the body of the component to separate from the support structure at the first sacrificial interface region more quickly than the body of the component separates from the support structure at the second sacrificial interface region when the chemical or electrochemical dissolution process is applied to the 3D printed piece.

12. The method of claim 11, wherein printing the second sacrificial interface region includes printing the second sacrificial interface region with a larger cross-sectional area than the first sacrificial interface region, and wherein applying the chemical or electrochemical dissolution process to the 3D printed piece causes the body of the component to separate from the support structure at the first sacrificial interface region more quickly than the body of the component separates from the support structure at the second sacrificial interface region due to differences in the cross-sectional area of the first sacrificial interface region and the second sacrificial interface region.

13. The method of claim 11, wherein adjusting the another one or more processing parameters while printing the second sacrificial interface region includes adjusting processing parameters differently than while printing the first sacrificial interface region, and wherein the adjustments to the another one or more processing parameters while printing the second sacrificial interface region are configured to cause the metal or ceramic material at the second sacrificial interface region to be less susceptible to the chemical or electrochemical dissolution process than the metal or ceramic material at the first sacrificial interface region and more susceptible to the chemical or electrochemical dissolution process than the metal or ceramic material at the body of the component.

14. The method of claim 1, wherein creating the 3D printed piece includes printing the 3D printed piece using steel, and wherein adjusting the one or more processing parameters while printing the first sacrificial interface region includes causing the body of the metal or ceramic component to be formed of stainless steel and causing the first sacrificial interface region to be formed of chromium deficient carbon steel.
